(19) United States
(12) Patent Application Publication
(10) Pub. No.: US 2013/0263504 A1
(43) Pub. Date: Oct. 10, 2013

(54) SUGARCANE COATING

(71) Applicant: Rakesh Kumar, Hillsboro, OR (US)

(72) Inventor: Rakesh Kumar, Hillsboro, OR (US)

(73) Assignee: SYNGENTA CROP PROTECTION LLC, Greensboro, NC (US)

(21) Appl. No.: 13/704,605

(22) PCT Filed: Jun. 13, 2011
(86) PCT No.: PCT/US11/40167

§ 371 Date: Mar. 4, 2013

Related U.S. Application Data
(60) Provisional application No. 61/354,862, filed on Jun. 15, 2010.

(51) Int. Cl. A01C 1/00

(52) U.S. Cl. CPC A01C 1/00
USPC 47/58.1 R

(57) ABSTRACT

Methods and coatings for a sugarcane stem section are shown and described. In one example, the disclosure includes a stem section that has been coated with a fatty acid component. In another example, the disclosure includes a method of growing sugarcane comprising planting a stem section that has been coated with a fatty acid component.

### TECHNICAL FIELD

The present inventions relate to the treatment of plant material and in particular the treatment of sugarcane stem sections.

### BACKGROUND

Sugarcane is a gramineous plant of commercial importance for a variety of reasons. For example, sugarcane is used for the production of sugar, Falernum, molasses, rum, cachaça (the national spirit of Brazil), and ethanol for fuel. Further, the biomass that remains after sugarcane crushing can also be used in furnaces and boilers.

Most commercial sugarcane is grown from stem sections (also known as cane cuttings or parts of a stalk or culms or carretels or seedlings). Stem sections may be produced from the stem of a sugarcane plant in any number of ways. For example, they may be formed manually or by a variety of machines. The resulting stem sections usually include several nodes per stem section. The term “node” means the part of the stem of a plant from which a leaf, branch, or aerial root grows.

After stem sections are planted, buds (or gemmas) may emerge at the position of each node. Buds may then grow to yield the crop plant. However, emergence rate, or the rate at which nodes bud to yield crop plants is sometimes poor in sugarcane. To improve the likelihood that each planted stem section will produce crop plants, stem sections are often planted with multiple nodes, e.g., 3, 4 or 5 nodes per stem section. These multi-node stem sections (or long stem sections) may have lengths of about 37 cm, 40 cm or greater.

Applicant believes that there are several disadvantages to using long stem sections. For example, long stem sections require larger areas for processing, which increases cost. Further, once cut, long stem sections require large areas to stock material, creating additional cost for the process. Also, the planting of long stem sections requires a high weight of material per hectare, such as 16-18 ton/ha (by mechanical planting) or 12-16 ton/ha (by conventional planting).

Applicant has found that using shorter stem sections and planting the stem sections in a field so that a substantial proportion of the stem sections of the crop that is planted or sown has one bud per stem section, many of the disadvantages of the state of art can be overcome because, for example, single node stem sections are much smaller and lighter than long stem sections. Single node stem sections are however are more susceptible to pests, disease, and dehydration, and therefore the rate of emergence from single bud stem sections may be lower than that of conventional stem sections. Therefore Applicant believes a need exists to improve the rate of emergence from single bud stem sections. Further, Applicant also believes that a need exists to improve the rate of emergence from long stem sections when conventional technologies are employed.

### SUMMARY

The present technologies address any number of the shortcomings of conventional sugarcane propagation and growing. In one example, the disclosure includes a method of coating a sugarcane stem section with a fatty acid component. In another example, the disclosure includes a stem section that has been coated with a fatty acid component. In another example, the disclosure includes a method of growing sugarcane comprising planting a stem section that has been coated with a fatty acid component. In another example, the disclose includes a method of preventing water loss from the sugarcane stem section by coating the a sugarcane stem section, or the exposed ends of a sugarcane stem section, with a fatty acid component.

The above summary was intended to summarize certain embodiments of the present disclosure. Systems, methods and compositions will be set forth in more detail, along with examples demonstrating efficacy, in the figures and detailed description below. It will be apparent, however, that the detailed description is not intended to limit the present invention, the scope of which should be properly determined by the appended claims.

### DETAILED DESCRIPTION OF EXEMPLARY TECHNOLOGY

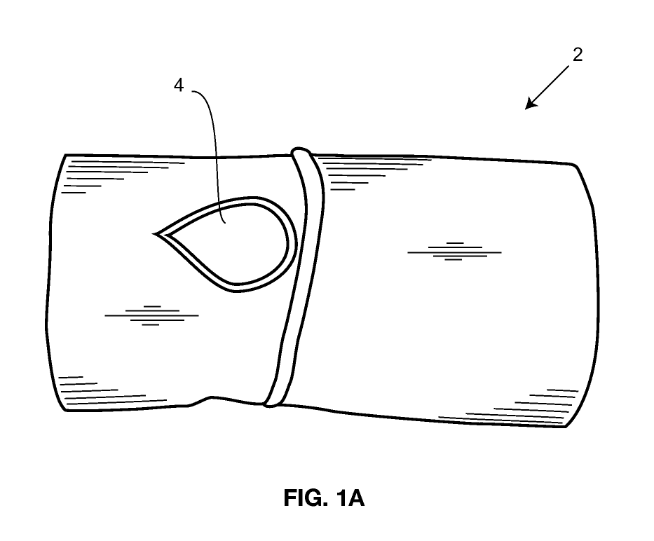

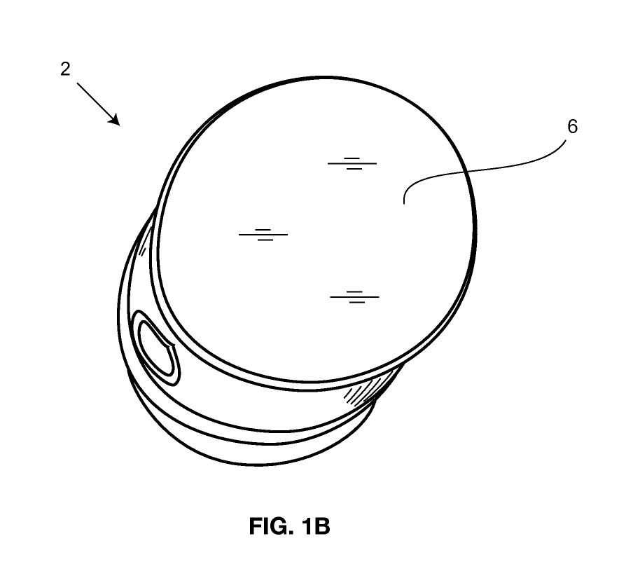

The current technology includes a method of treating a sugarcane stem section. In one example, the method includes coating the stem section with a fatty acid component. FIGS. 1a and 1b illustrate side and end views, respectively, of one example of a stem section 2 before a coating has been applied. Stem section 2 was prepared by cutting a sugarcane stem to the desired length. Node 4 of stem section 2 is visible in FIG. 1a. Exposed vascular bundles (EVB) 6 on one end are visible in FIG. 1b. As used herein, EVB may include the cross-section of the sugarcane stem, including xylem and phloem of the vascular bundles as well as the pith and the cortex. The opposite end of cane cutting 2 will have similar EVB. In other examples, stem sections may include more nodes.

Treatment involves coating the stem section, e.g. at least one part of the stem section, with a fatty acid component. The term “fatty acid component” as utilized herein is intended to include at least one of fatty acids and salts of fatty acids. A fatty acid is composed of a hydrocarbon chain (or tail) and a terminal carboxyl group (or head). Common biological fatty acids include lauric acid, myristic acid, plamitic acid, stearic acid, arachidic acid, behenic acid, lignoceric acid, palmitoleic acid, oleic acid, linoleic acid, arachidonic acid, and nervonic acid. An exemplary fatty acid component will include a triglyceride (also called triacylglycerol).

Fatty acid components may include any of animal fats, animal oils, vegetable fat, and a vegetable oil. Any of these components may further be hydrogenated and/or fractionated. For example, fatty acid components may also include hydrogenated animal fats, hydrogenated animal oils, hydrogenated vegetable fats, hydrogenated vegetable oils. Fatty acid components may also include stearines, tallows, and butters, and hydrogenated stearines, hydrogenated tallows, and hydrogenated butters.

Hydrogenated oils, fats, stearines, tallows and butters may be produced by chemical reactions that result in the addition of hydrogen. In many instances, oils and fats, for example, are hydrogenated using a catalyst, e.g. some form of platinum or nickel, to facilitate the addition of hydrogen. Hydrogenated oils, fats, stearines, tallows and butters may include fully hydrogenated products and partially hydrogenated products. Fully hydrogenated products include oils, fats, stearines, tallows and butters that have been hydrogenated to complete saturation. Partially hydrogenated products include oils, fats, stearines, tallows and butters that have at least some degree of hydrogenation, but that are not fully hydrogenated.

Stearines include the solids formed from the fractionation of oils or fats. Fractionation is a physical method using the crystallization properties of triglycerides to separate a mixture into a low melting liquid fraction and a high melting liquid fraction. Fractionation may be performed by a variety of methods including dry fractionation, detergent fractionation, and solvent fractionation. Tallows include solids rendered from animal or plant fats or oils using heat. Butters include solids that have been physically separated, e.g. by churning or pressing, from a liquid or paste derived from a plant or animal. Exemplary butters include milk butter and cocoa butter.

In many examples, the fatty acid component will include hydrogenated vegetable oil as a major component, e.g. at least any of greater than 50%, greater than 55%, greater than 60%, greater than 65%, greater than 70%, greater than 75%, greater than 80%, greater than 85%, greater than 90%, and greater than 95%. A variety of hydrogenated vegetable oils may be used, including, but not limited to, for example, at least one of hydrogenated soybean oil, hydrogenated coconut oil, hydrogenated canola oil, hydrogenated castor oil, hydrogenated corn oil, hydrogenated cotton seed oil, hydrogenated sunflower oil, hydrogenated palm oil, hydrogenated palm kernel oil, and hydrogenated cocoa oil.

The melting point temperature (Tₘ) of fatty acid components herein may vary. In one example, fatty acid components will have a Tₘ of at least 24° C. Because fatty acid components may include a variety of different fatty acids, e.g., of different length, different origin, different saturation, different cis-trans isomers, etc., any fatty acid component may melt over a range. As used herein, Tₘ refers to the temperature at which a fatty acid component begins to melt. Fatty acid components may have a variety of Tₘ, for example, Tₘ may be within at least one of the following ranges: 24 to 68° C., 28 to 66° C., 28 to 64° C., 28 to 62° C., 28 to 60° C., 30 to 60° C., 32 to 60° C., 34 to 58° C., 34 to 56° C., 34 to 54° C., and 34 to 52° C. Further, Tₘ may be at least any temperature falling within any of the noted ranges.

Fatty acid components may be used to coat stem sections in a variety of ways, e.g., in batches or continuously. Coating may be achieved by any combination of spraying, dipping, brushing, smearing, etc., of the fatty acid component onto the stem section. Coatings may be applied to the entire stem section or applied to parts of the stem section. In one example, a coating is applied to EVB located on one end of the stem section. In another example, a coating is applied to EVB located on both ends of the stem section. In some situations, a stem section may be hydrated, e.g. by soaking in water, prior to coating. Further, in some situations, a stem section may be treated with a pesticide prior to coating, e.g., by being sprayed, dipped or soaked in a pesticide or pesticidal solution.

Application rates may vary as needed depending on the amount of surface area per stem section being covered. For example, if only the ends of the stem section are being coated, coatings may be applied at 0.2 to 5 g per stem section. If more of the stem section is being coated, application rates may be increased.

Methods may also include heating the fatty acid component to at least a softening point temperature prior to coating. In many examples, the fatty acid component will be heated until the fatty acid component becomes liquid. Heating may be performed in a variety of ways, e.g. water bath, microwave, heating filament, steam, etc. Heating temperatures may vary depending on the Tₘ of the fatty acid component. Exemplary temperatures include a temperature within at least one of the following ranges: Tₘ±1° C., Tₘ±2° C., Tₘ±3° C., Tₘ+4° C., Tₘ+5° C., Tₘ+6° C., Tₘ+7° C., Tₘ+8° C., Tₘ+9° C., Tₘ+10° C., Tₘ+11° C., Tₘ+12° C., Tₘ+13° C., Tₘ+14° C., and Tₘ+15° C., Tₘ+20° C., and Tₘ+25° C. prior to coating. Others examples include higher and lower temperatures. Methods may further include allowing the fatty acid component to cool to at least ambient temperature or below after coating. Coated stem sections may be planted or stored for shipping or planting at a later time.

The following examples are for illustration only, and are in no way intended to limit the scope of the invention.

### Experiment 1: Moisture-loss Reduction in Coated Stem Sections

Stem sections having a diameter of approximately 25-30 mm and a length of approximately 50 mm were generated from sugarcane stalks. Fatty acid components were melted in a water bath having a temperature about 5° C. above the Tₘ of the fatty acid component or greater. Fatty acid component was applied to the EVB of the stem section at approximately 0.2 to 0.25 g per cut end. Coatings were allowed to harden by cooling and then left in exposed drying trays for several days. Treatments are contained in Table 1 below.

TABLE 1

| Sample | Description | Melting Point | | Source |
|---|---|---|---|---|
| HOC865 | Hydrogenated Coconut | 110° | F. | Archer Daniels |
| | Oil + Hydrogenated | | | Midland Company, |
| | Soybean Oil | | | NOVALIPID |
| | | | | 110°F. |
| HOC592 | Hydrogenated Coconut | 92° | F. | Archer Daniels |
| | Oil | | | Midland Company, |
| | | | | NOVALIPID 92°F. |
| HOP650 | Palm Oil | 109-119° | F. | Archer Daniels |
| | | | | Midland Company |
| HOPS560 | Palm Stearine | 125-135° | F. | Archer Daniels |
| | | | | Midland Company |

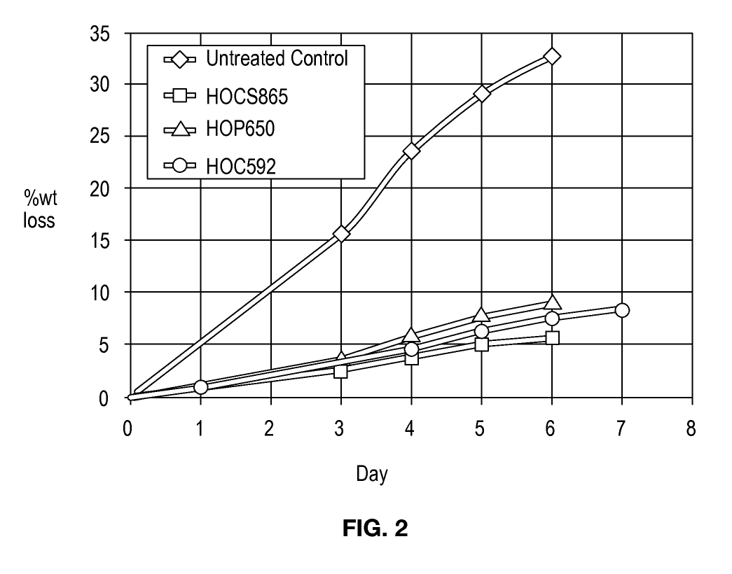

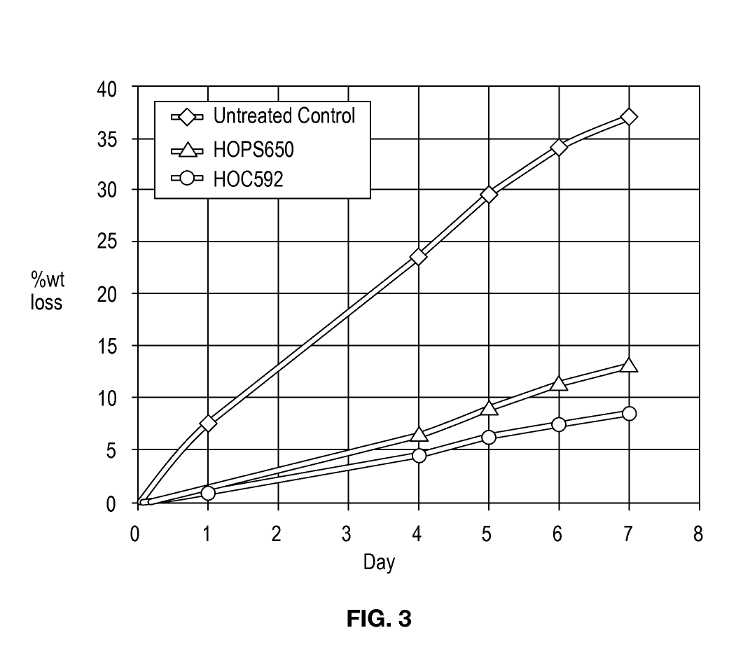

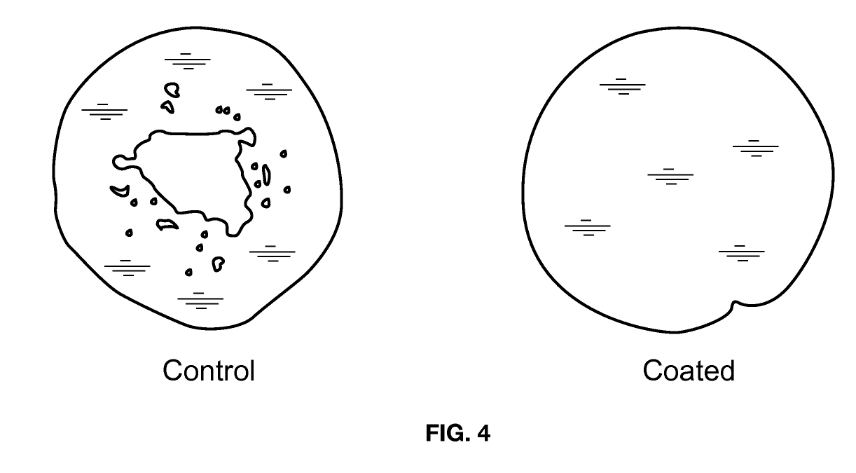

Coatings provided good moisture loss relative to the uncoated control. Results are summarized in the graphs contained in FIG. 2 and FIG. 3. FIG. 4 also shows a photograph of EVB of a control stem section relative to a coated stem section at 4 days after treatment. The improvement relative to the control is readily visible.

### Experiment 2: Surface Wetness

In some instances, stem sections may have surface wetness after preparation, for example, because of rain or dew. Experiment 2 examines the ability of fatty acid components to adhere to stem sections having surface wetness.

Stem sections were generated from sugarcane stalks as described in Experiment 1. Treatments included (1) Water soaked stem section+fatty acid component (HOC_PARA); (2) an unsoaked stem section+fatty acid component (HOC_PARA); and (3) an untreated control. HOC_PARA is a hydrogenated coconut oil (Tₘ=92° F.) similar to HOC592 from Experiment 1.

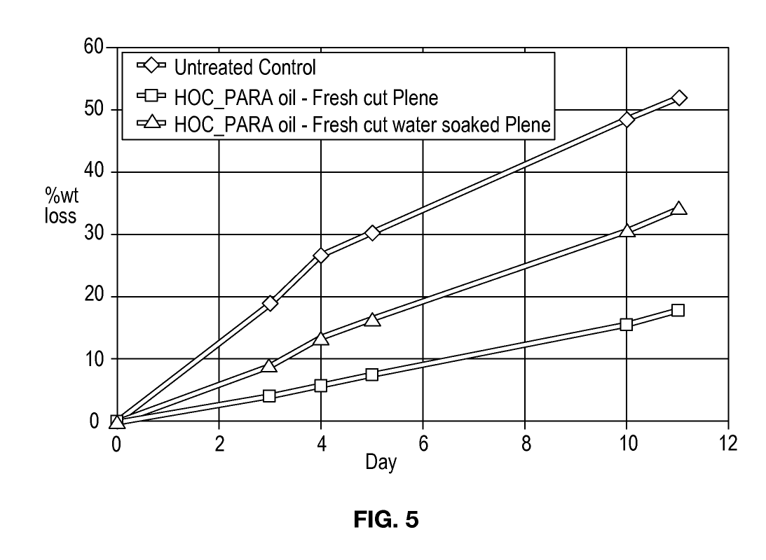

Results are summarized in FIG. 5 (“Plene” refers to a stem section). As seen, coatings were effective at reducing water loss even in samples that were coated with surface wetness.

### Experiment 3: Application Rate Efficacy

The efficacy of different fatty acid component application rates was examined. Stem sections were generated from sugarcane stalks as described in Experiment 1. Treatments included (1) fatty acid component (HOC592) applied to stem sections at 0.1 g per cut end; (2) fatty acid component (HOC592) applied to stem sections at 0.2 g per cut end; and (3) untreated control.

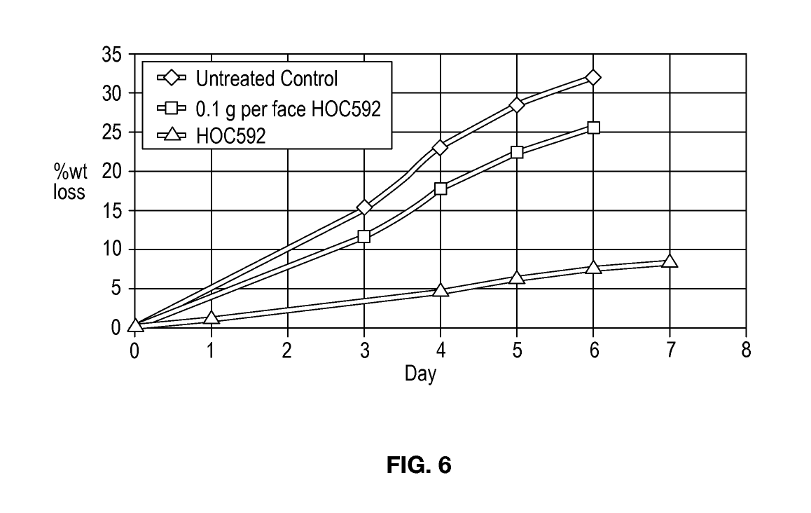

Results are summarized in FIG. 6. Both application rates were effective at reducing water loss relative to the control. The higher application rate however produced a signification improvement in water loss reduction.

In many examples, e.g., those described above, the coating may be entirely fatty acid component, e.g., 100% hydrogenated vegetable oil or some other fatty acid component or combination thereof. In other examples, however, the fatty acid component may be a component of a treatment composition. For example, the composition may include a carrier, e.g., another component such as water or alcohol to facilitate any combination of storage, transport, or application. In other examples, treatment compositions may include fertilizers, pesticides, stabilizers, etc. Where the fatty acid component is a component of a treatment composition, the concentration of the fatty acid component may vary as needed. For example, treatment compositions include 50 to 99.5%, 70 to 99%, or some other amount of the fatty acid component.

The current disclosure is also directed to methods of growing sugarcane. In one example a method includes obtaining a stem section having EVB and at least one node, coating the stem section with a fatty acid component, e.g., any of the fatty acid components described above, and planting the coated stem section. Stem sections may be obtained in a variety of ways, for example, by cutting the stalk of a sugarcane plant to the desired length and having the desired number of nodes. En exemplary stem section may have one node and be 3 to 4 cm long. Methods of growing may further include heating the fatty acid component prior to coating, for example, as described above.

The current disclosure is also directed to sugarcane propagation systems. In one example, the system includes a stem section having at least one bud and exposed vascular bundles (EVB). A fatty acid component, e.g. as described above, coats at least the EVB.

Using methods and systems as described herein, Applicant believes the emergence rate of sugarcane plants from stem sections will be improved. Applicant believes improvements will be seen in long stem sections as well as in stem sections having a singe node. Further, Applicant believes that using methods and systems described herein will decrease the cost of at least one of processing, stocking and planting. Further still, Applicant believes transport and storage of stem sections will be improved.

Numerous characteristics and advantages have been set forth in the foregoing description, together with details of structure and function. The disclosure, however, is illustrative only, and changes may be made in detail within the principle of the invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein, and every number between the end points. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10, as well as all ranges beginning and ending within the end points, e.g. 2 to 9, 3 to 8, 3 to 9, 4 to 7, and finally to each number 1, 2, 3, 4, 5, 6, 7, 8, 9 and 10 contained within the range.

It is further noted that, as used in this specification, the singular forms “a,” “an,” and “the” include plural referents unless expressly and unequivocally limited to one referent.

What is claimed is:

1. A method of treating a sugarcane stem section, the method comprising coating the stem section with a fatty acid component having a melting point temperature (Tₘ) of at least 24° C.

2. The method of claim 1, wherein the fatty acid component has a melting point in a range chosen from at least one of 24 to 68° C., 28 to 66° C., 28 to 64° C., 28 to 62° C., 28 to 60° C., 30 to 60° C., 32 to 60° C., 34 to 58° C., 34 to 56° C., 34 to 54° C., and 34 to 52° C.

3. The method of claim 1, wherein the fatty acid component is chosen from at least one of a hydrogenated animal fat, a hydrogenated animal oil, a hydrogenated vegetable fat, a hydrogenated vegetable oil, a stearine, a hydrogenated stearine, a tallow, a hydrogenated tallow, a butter, and a hydrogenated butter.

4. The method of claim 3, wherein
the hydrogenated animal fat includes at least one of partially hydrogenated animal fat and fully hydrogenated animal fat,
the hydrogenated animal oil includes at least one of partially hydrogenated animal oil and fully hydrogenated animal oil,
the hydrogenated vegetable fat includes at least one of fully hydrogenated vegetable fat and partially hydrogenated vegetable fat,
the hydrogenated vegetable oil includes at least one of fully hydrogenated vegetable oil and partially hydrogenated vegetable oil,
the hydrogenated stearine includes at least one of a fully hydrogenated stearine and a partially hydrogenated stearine,
the hydrogenated tallow includes at least one of a fully hydrogenated tallow and a partially hydrogenated tallow, and
the hydrogenated butter includes at least one of a fully hydrogenated butter and a partially hydrogenated butter.

5. The method of claim 1, wherein the fatty acid component includes a hydrogenated vegetable oil.

6. The method of claim 5, wherein the hydrogenated vegetable oil is chosen from at least one of hydrogenated soybean oil, hydrogenated coconut oil, hydrogenated canola oil, hydrogenated castor oil, hydrogenated corn oil, hydrogenated cotton seed oil, hydrogenated sunflower oil, hydrogenated palm oil, hydrogenated palm kernel oil, and hydrogenated cocoa oil.

7. The method of claim 1, further including heating the fatty acid component to at least a softening point temperature prior to coating.

8. The method of claim 1, wherein the fatty acid component is heated to a temperature in a range chosen from at least one of Tₘ±1° C., Tₘ±2° C., Tₘ±3° C., Tₘ+4° C., Tₘ+5° C., Tₘ+6° C., Tₘ+7° C., Tₘ+8° C., Tₘ+9° C., Tₘ+10° C., Tₘ+11° C., Tₘ+12° C., Tₘ+13° C., Tₘ+14° C., and Tₘ+15° C., Tₘ+20° C., and Tₘ+25° C. prior to coating.

9. The method of claim 8, further include allowing the fatty acid component to cool to at least ambient temperature or below after coating.

10. The method of claim 1, wherein the coating is performed by at least one method chosen from dipping, spraying, brushing and smearing.

11. The method of claim 1, wherein the stem section has exposed vascular bundles (EVB), and wherein the EVB are coated with the fatty acid component.

12. The method of claim 1, wherein the stem section has at least one node.

13. The method of claim 1, wherein the coating is applied at 0.2 to 5 g per stem section.

14. The method of claim 1, wherein the fatty acid component is a component of a treatment composition.

15. The method of claim 14, wherein the treatment composition includes 50 to 99.5% of the fatty acid component.

16. The method of claim 1, further including treating the stem section with a pesticide prior to coating.

17. A method of treating a sugarcane stem section, the method comprising
obtaining a stem section having exposed vascular bundles (EVB) and at least one bud;
obtaining a fatty acid component having a melting point temperature (Tₘ) of at least 24° C.;
heating the fatty acid component to at least its softening temperature;
coating the EVB with heated fatty acid component; and
allowing the coating to cool.

18. The method of claim 17, wherein the fatty acid component is chosen from at least one of hydrogenated soybean oil, hydrogenated coconut oil, hydrogenated canola oil, hydrogenated castor oil, hydrogenated corn oil, hydrogenated cotton seed oil, hydrogenated sunflower oil, hydrogenated palm oil, hydrogenated palm kernel oil, hydrogenated cocoa oil, a stearine, a hydrogenated stearine, a tallow, a hydrogenated tallow, a butter, and a hydrogenated butter.

19. A method of growing sugarcane comprising
obtaining a stem section having exposed vascular bundles (EVB);
coating the EVB with a fatty acid component having a melting point temperature (Tₘ) of at least 24° C.; and
planting the coated stem section in the ground.

20. The method of claim 19, wherein the fatty acid component has a melting point in a range chosen from at least one of 24 to 68° C., 28 to 66° C., 28 to 64° C., 28 to 62° C., 28 to 60° C., 30 to 60° C., 32 to 60° C., 34 to 58° C., 34 to 56° C., 34 to 54° C., and 34 to 52° C.

21. The method of claim 19, wherein the fatty acid component is chosen from at least one of a hydrogenated animal fat, a hydrogenated animal oil, a hydrogenated vegetable fat, a hydrogenated vegetable oil, a stearine, a hydrogenated stearine, a tallow, a hydrogenated tallow, a butter, and a hydrogenated butter.

22. The method of claim 21, wherein
the hydrogenated animal fat includes at least one of partially hydrogenated animal fat and fully hydrogenated animal fat,
the hydrogenated animal oil includes at least one of partially hydrogenated animal oil and fully hydrogenated animal oil,
the hydrogenated vegetable fat includes at least one of fully hydrogenated vegetable fat and partially hydrogenated vegetable fat,
the hydrogenated vegetable oil includes at least one of fully hydrogenated vegetable oil and partially hydrogenated vegetable oil,
the hydrogenated stearine includes at least one of a fully hydrogenated stearine and a partially hydrogenated stearine,
the hydrogenated tallow includes at least one of a fully hydrogenated tallow and a partially hydrogenated tallow, and
the hydrogenated butter includes at least one of a fully hydrogenated butter and a partially hydrogenated butter.

23. The method of claim 19, wherein the fatty acid component includes a hydrogenated vegetable oil.

24. The method of claim 23, wherein the hydrogenated vegetable oil is chosen from at least one of hydrogenated soybean oil, hydrogenated coconut oil, hydrogenated canola oil, hydrogenated castor oil, hydrogenated corn oil, hydrogenated cotton seed oil, hydrogenated sunflower oil, hydrogenated palm oil, hydrogenated palm kernel oil, and hydrogenated cocoa oil.

25. The method of claim 19, further including heating the fatty acid component to at least a softening point temperature prior to coating.

26. The method of claim 19, wherein the fatty acid component is heated to a temperature in a range chosen from at least one of Tₘ±1° C., Tₘ±2° C., Tₘ±3° C., Tₘ+4° C., Tₘ+5° C., Tₘ+6° C., Tₘ+7° C., Tₘ+8° C., Tₘ+9° C., Tₘ+10° C., Tₘ+11° C., Tₘ+12° C., Tₘ+13° C., Tₘ+14° C., and Tₘ+15° C. prior to coating.

27. The method of claim 26, further include allowing the fatty acid component to cool to at least ambient temperature or below after coating.

28. The method of claim 19, wherein the coating is performed by at least one method chosen from dipping, spraying, brushing and smearing.

29. The method of claim 19, wherein the stem section has at least one node.

30. A sugarcane propagation system comprising:
a stem section having at least one bud and exposed vascular bundles (EVB), and
a fatty acid component coating the EVB, wherein the fatty acid component has a melting point temperature (Tₘ) of at least 24° C.

31. The system of claim 30, wherein the fatty acid component has a melting point in a range chosen from at least one of 24 to 68° C., 28 to 66° C., 28 to 64° C., 28 to 62° C., 28 to 60° C., 30 to 60° C., 32 to 60° C., 34 to 58° C., 34 to 56° C., 34 to 54° C., and 34 to 52° C.

32. The system of claim 31, wherein the fatty acid component is chosen from at least one of a hydrogenated animal fat, a hydrogenated animal oil, a hydrogenated vegetable fat, a hydrogenated vegetable oil, a stearine, a hydrogenated stearine, a tallow, a hydrogenated tallow, a butter, and a hydrogenated butter.

33. The system of claim 32, wherein
the hydrogenated animal fat includes at least one of partially hydrogenated animal fat and fully hydrogenated animal fat,
the hydrogenated animal oil includes at least one of partially hydrogenated animal oil and fully hydrogenated animal oil,
the hydrogenated vegetable fat includes at least one of fully hydrogenated vegetable fat and partially hydrogenated vegetable fat,
the hydrogenated vegetable oil includes at least one of fully hydrogenated vegetable oil and partially hydrogenated vegetable oil,
the hydrogenated stearine includes at least one of a fully hydrogenated stearine and a partially hydrogenated stearine,
the hydrogenated tallow includes at least one of a fully hydrogenated tallow and a partially hydrogenated tallow, and
the hydrogenated butter includes at least one of a fully hydrogenated butter and a partially hydrogenated butter.

34. The system of claim 30, wherein the fatty acid component includes a hydrogenated vegetable oil.

35. The system of claim 34, wherein the hydrogenated vegetable oil is chosen from at least one of hydrogenated soybean oil, hydrogenated coconut oil, hydrogenated canola oil, hydrogenated castor oil, hydrogenated corn oil, hydrogenated cotton seed oil, hydrogenated sunflower oil, hydrogenated palm oil, hydrogenated palm kernel oil, and hydrogenated cocoa oil.
